(19) United States
(12) Patent Application Publication
(10) Pub. No.: US 2015/0090128 A1
(43) Pub. Date: Apr. 2, 2015

(54) SYSTEM FOR ADMIXTURE OF A MATERIAL IN POWDER OR LIQUID FORM

(71) Applicant: Amcor Flexibles Denmark A/S, Horsens (DK)

(72) Inventor: Peter Hansen, Vejle Ost (DK)

(21) Appl. No.: 14/390,404

(22) PCT Filed: Mar. 21, 2013
(86) PCT No.: PCT/EP2013/055903

§ 371 Date: Oct. 3, 2014

(30) Foreign Application Priority Data
Apr. 4, 2012 (EP) 12163148.5

(51) Int. Cl. A47J 31/36; B65D 85/804

(52) U.S. Cl. CPC A47J 31/3685; B65D 85/8046
USPC 99/295

(57) ABSTRACT

The invention concerns a system (1) for admixture of a material in powder or liquid form into a fluid stream comprising a container (5) enclosing the material (8). The container cooperates with an outlet (3) of a fluid dispensing unit (4) such as a spigot or faucet and at least a part of the container (5) is permeable for the fluid (9) dispensed from the fluid dispensing unit (4). Further the system (1) comprises a device (2) configured to cooperate with the outlet and the container(5), and the device (2) is made in a material non-permeable for the fluid (9) and said system comprises position means (6) configured to position and to sustain the container(5) in a defined relation to said device (2).

The invention relates to a system for handling a material of solid particles such as granular, flakes or powder into a fluid stream, said fluid stream being a water stream, the system comprising a container enclosing the material, said container cooperating with an outlet of a tap or faucet comprising a spout having a spout outlet and at least a part of the container being permeable for the fluid dispensed from the tap/faucet, said system further comprising a device configured to cooperate with the outlet and the container, said device being made in a material non-permeable for the fluid, and said system comprising position means configured to position and to sustain the container in a defined relation to said device, said container comprising a top part, a bottom part, side parts, a fluid inlet and a fluid outlet.

WO 99/38395 discloses a dispensing article comprising a cylindrical-formed container. A dispensate is placed inside said container. The cylindrical article may be configured for attachment to a faucet, and water passes from the outlet through the dispensate inside the article and flows out. However, the construction suffers from the draw back that the container and the dispensate are an integrated unit and provide an inflexible construction only suitable for one type of faucets.

WO 2008/018794 discloses an apparatus enclosing a pad filled with a product to be dissolved or extracted. The apparatus comprises a container filled with water. The water is warmed up by heating elements in the machine and the hot water is led to the pad, whereby brewing of a hot drink takes place. The apparatus cannot be connected to a faucet and is only suitable to handle pad-formed containers made in a non-woven or porous material.

U.S. Pat. No. 7,650,830 discloses a dispensing article comprising a cartridge in which a bladder comprising a liquid or a dissolvable solid is placed. Water enters the bottom of the cartridge and dissolves the substance in the bladder and leaves the cartridge through an outlet also placed in the bottom of the cartridge. The system is not suitable for extracting flavour or nutrients such as caffeine from a granulated material due to the construction of the bladder and the position of the inlet and outlet at the bottom. The system is only suitable for dissolving a substance in water. Further, the system is not placed in connection to the spout but at the top of the outlet, which makes the attachment to the faucet and the construction as such quite complicated.

One aspect of the present invention is to provide a new construction of a system for admixture of a material in solid particle form such as granulated material, flakes or powder into a fluid stream solving at least one of the problems mentioned in the prior art or at least providing a useful alternative.

According to a first aspect of the invention, a system is provided as described in the introduction and the device is adapted to be placed in the spout outlet and the fluid inlet is placed in the top part of the container and the outlet is placed in the oppositely placed bottom part and/or lower part of the side parts, whereby the fluid passes through the solid particles from the top to the lower part of the container extracting the flavour and nutrients of the solid particles.

The system renders it possible to attach a container enclosing a material, such as coffee powder, tea powder, soup powder or other tasty powders of various kinds, to a fluid dispensing unit, such as a tap/faucet comprising a wide variety of constructions. The attachment takes place by means of the device that may be a type of adapter. The adapter attaches the container in one end and connects to the spout of the faucet in the opposite end. The adapter may be a separate unit or it may be an integrated part of the faucet. It may also be a part that is especially fabricated for the specific faucet in question or it may be an integral but specially designed part of the container suitable for connecting to a specific faucet. In principal, the system is also suitable for containers enclosing liquids.

When the container is attached to the faucet, the faucet is opened and water flows out. A faucet constructed for boiling water is chosen when for instance tea or coffee is to be brewed. The fluid passes through the container and dissolves or extracts the material inside the container, and the fluid containing the dissolved or extracted material passes through the bottom or the lower part of the sides of the container into a cup. Thereby, the water is passing all of the solid material inside the container maximising the extraction.

By the arrangement, it is easy to brew a tasty drink. When the drink is a hot drink, the invention is very energy-saving and time-saving as it exploits the fact that many modern kitchens have a special faucet or tap from which boiling water is obtainable. For example, such a faucet is Quooker Fusion 3i1. This is a tap/faucet comprising a mixer tap and a boiling water tap in one single construction. In this way, only one tap is necessary and a separate water boiler is not needed.

By this arrangement, only the amounts necessary for a cup of coffee or hot drink is boiled. However the invention is also suitable for making drinks based on cold water. Thereby, drinks such as ice tea and energy drinks are brewed.

Further, the powder may be dissolved in the water passing through the interior of the container. This is the case when brewing instant coffee or soup and the container comprises such solid particles, but the main purpose is to extract the powder, which is used e.g. when brewing coffee. Extraction of the flavour and nutrients including caffeine is important.

The permeability of the container may be obtained by choosing a liquid-permeable material. It may also be obtained by a part of the container being opened physically/torn apart. If for instance a high liquid pressure is used and the liquid flows into the interior of the container, the pressure may be adapted to break through a weld being advantageously placed at the bottom of the container. Subsequently, the liquid will pass through the opening. By liquid-permeable is therefore to be understood that the material of the walls of the container is permeable for liquid or that a part of the walls is adapted to be broken, whereby an opening is achieved.

The container may be constructed in many ways. It could be a capsule characterised by a cup-shaped form and made in a hard material comprising perforations in the top, thereby allowing the liquid to flow in, comprising a filter and/or perforations in the bottom allowing the tasty liquid to pass out and pass into a cup placed below the faucet/tap.

The container could be a pad-formed article made in a flexible material such as paper or a non-woven material. The walls act as a filter in this embodiment of the container and the fluid passes through the pores of the material.

The container could also be a pouch comprising flexible walls and an inlet part. In this embodiment the walls will be manufactured in a laminate; the laminate could for example comprise layers of polyester, aluminium or polypropylene laminate. This is only one example of several suitable laminates. In the top wall of the pouch, the inlet part is attached and made in a hard plastic material.

The device may be made in a plastic material such as polypropylene or other plastic materials that may withstand the high temperature and the high pressure or it may be made in metal or a composite.

The material could be any tasty granular, flake, powder (or liquid) such as: coffee, tea, cacao, soup, energy mass and so on.

By the inventive construction, the time for fluid passing through the interior of the container is maximized, thereby optimizing the extraction of flavour and nutrients when the container comprises tasty solid particles.

In a further embodiment, the fluid inlet comprises pores or perforations, said pores or perforations having a diameter of 50 my-300 my.

Thereby, it is obtained that the liquid (the hot water) has a certain retention time inside the container and that the liquid is not passing through the capsula to fast, thus performing a poor extraction from the solid material.

In a further embodiment, the fluid inlet comprises pores or perforations, said pores or perforations having a diameter of 100 my-250 my.

In a further embodiment, the fluid outlet comprises pores or perforations, said pores or perforations having a diameter of 50 my-300 my.

In a further embodiment, the fluid outlet comprises pores or perforations, said pores or perforations having a diameter of 100 my-250 my.

In a further embodiment, the fluid inlet comprises one single inlet allowing the water to pass through with little resistance.

In a further embodiment, the pressure of the fluid is 2-8 bar and said pressure is constant during the extraction of the flavour/nutrients.

This pressure sees to that the extraction performance is maximised. This is also the pressure of commercially available boiled water faucets.

In a further embodiment, the tap/faucet comprises a boiling water faucet/tap, said water leaving the faucet/tap having an even/uniform pressure and a temperature in the range of 70-100°C.

In a further embodiment, the container comprises a capsula, said bottom part and top part of the capsula being made in a polymer material and comprising perforations through which the fluid passes.

In a further embodiment, the walls of the container have a thickness of 400-600 my.

In a further embodiment, the inlet of the container comprises several minor inlets and the outlet of the container comprises several minor outlets.

Advantageously, the outlet area through which the liquid is leaving the container is smaller than the inlet area through which the liquid is entering the interior of the container. Thereby, it is obtained that a sufficient pressure is build up inside the container, thus maximising the extraction.

In a further embodiment, the container is made in a non-women material and the inlet and the outlet comprise the pores of the material.

In a further embodiment, the outlet is placed in the bottom part of the container, whereby the fluid passes through the bottom when leaving the container.

In a further embodiment, the container comprises a circumferential collar (33), said collar being adapted to engage the device.

The collar is made in a polymer material having a certain stiffness.

In a further embodiment, the second position means comprises a part circular recess, the collar being adapted to press fit into said recess.

In a further preferred embodiment, said system further comprises engaging means for engaging the device and the fluid dispensing unit.

Thereby, the two parts of the system are connected to each other when the system is to be used for brewing a drink.

In a further embodiment, the position means comprise first position means being a part of the container and second positions means being a part of the device, said first and second position means being configured to engage with each other, whereby the container is attached to the device.

By constructing the position means as two separate units belonging to separate items, it is possible to construct the position means belonging to the container as a function dependent on the construction of the second position means. Thereby, containers with different material content may be provided having position means suitable for many different constructed devices. This makes the system very flexible.

In a further embodiment, the container is formed with a top part and an oppositely placed bottom part, said parts connected to each other by side parts, whereby the closed container is formed and encloses the material, where at least the bottom part is liquid-permeable. Thereby, the fluid will be transported through the interior of the container and leaves the container through the bottom.

In a further preferred embodiment, the top part is configured to give access to the liquid, whereby the liquid flows into the interior of the container. This is an appropriate place for placing the inlet for the fluid passing into the container.

In a further preferred embodiment, the engaging means comprise first engaging means being an integrated part of the device and second engaging means being a part of the outlet, said first and second engaging means being configured to interconnect.

Thereby, the device is a separate unit and may be constructed to fit to any chosen outlet and thereby, any chosen faucet may be used. Advantageously, the second engaging means are not separable from the outlet and are an integral part of the outlet/the faucet.

In a further preferred embodiment, the first engaging means are formed as a pater part fitting into the second engaging means formed as a mater part surrounding the pater part, or the first engaging means are formed as a mater part surrounding the second engaging means formed as a pater part, said mater and pater part fitting each other.

This is a suitable way of constructing the engaging means. The pater part may be a part that press fits into the mater part, or the pater part may have external threads engaging with interior threads placed at the mater part.

In a further preferred embodiment, the first and the second engaging means are formed as threads engaging with each other.

In a further preferred embodiment, the device is an integral part of the outlet of the fluid dispensing unit, whereby the engaging means comprise the device and an outlet part of the fluid dispensing unit, said two parts being formed as one unit.

This is a suitable embodiment, where the outlet is formed in such a way making it possible to attach the position means of the container directly to the outlets. This is particularly interesting for faucets having a suitable predefined construction.

In a further preferred embodiment, the device is a separate unit such as an adapter.

In a further preferred embodiment, the first and the second position means are formed as an integral unit and are inseparable.

This is an advantageous embodiment, where the container may be connected directly to an outlet without any use of an adapter as the device is now an integral part of the container.

In a further preferred embodiment, the first position means are formed as a connecting pipe fitting into the second position means being formed as a recess enclosing at least a part of the connecting pipe, whereby the first and the second position means are configured to be separable.

This is an advantageous embodiment.

In a further preferred embodiment, the second position means comprise a hinged and liquid-permeable plate covering the outlet of the fluid dispensing unit, said plate being able to have at least two positions, a first position where the plate is covering the outlet and comprises means for firmly securing the plate to the outlet, and a second position—an open position—where there is access to the outlet.

This is an advantageous embodiment, where the container may be formed just as a pad and is placed in the opening resting at the surface of the plate, said plate then being closed. The plate is formed with small openings forming a strainer construction. When the fluid is passing, it flows through the permeable walls/sheets of the container/pad into the interior of the container and dissolves the material inside said container. Thereafter, it leaves the container and passes the openings of the plate and falls into a cup or similar.

In a further advantageous embodiment, the second position means comprise a hinged side plate, said side plate being hinged in such a way that in a closed position, the longitudinal axis of the plate is parallel to the longitudinal axis of the outlet and is angled with the longitudinal axis in an open position, said angle being measured where a hinge is placed.

Thereby, the construction of the second position means allows the container, including the first position means, to be placed from the lateral side of the outlet.

In a further preferred embodiment, the first and second engaging means are an integral unit comprising the engaging means.

In a further preferred embodiment, the second positions means is integrated in the engaging means.

In a further preferred embodiment, the device is a part of the outlet part.

The invention further comprises a container suitable for a system as described above, said container comprising an article enclosing the material, and the container further comprises first position means configured to engage a device or an outlet being part of a fluid dispensing unit, said at least a part of the container being permeable for the liquid dispensed from the fluid dispensing unit, said fluid dispensing unit being a faucet/tap.

The invention is explained in detail below with reference to the drawings, in which

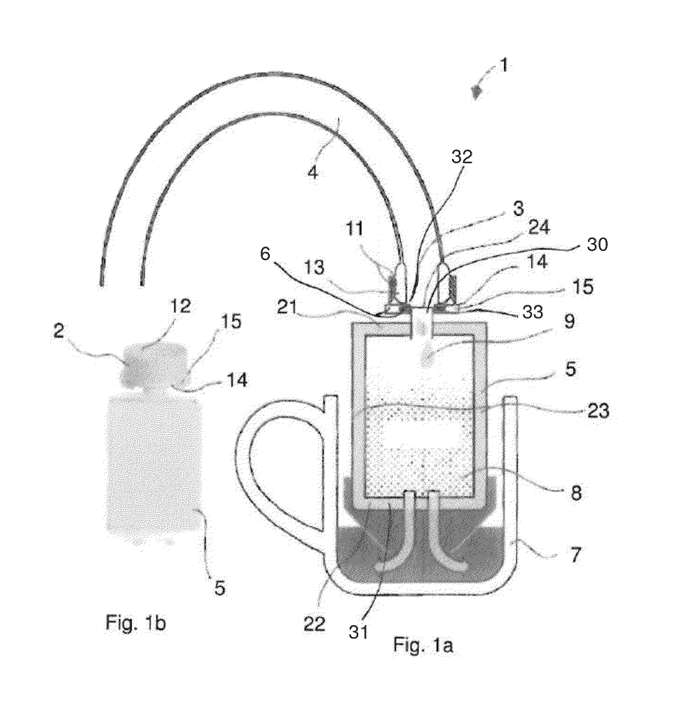

FIG. 1a shows a first embodiment of the system according to the invention and the relation to a faucet and a cup.

FIG. 1b shows a part of the system of FIG. 1a in a detailed perspective view.

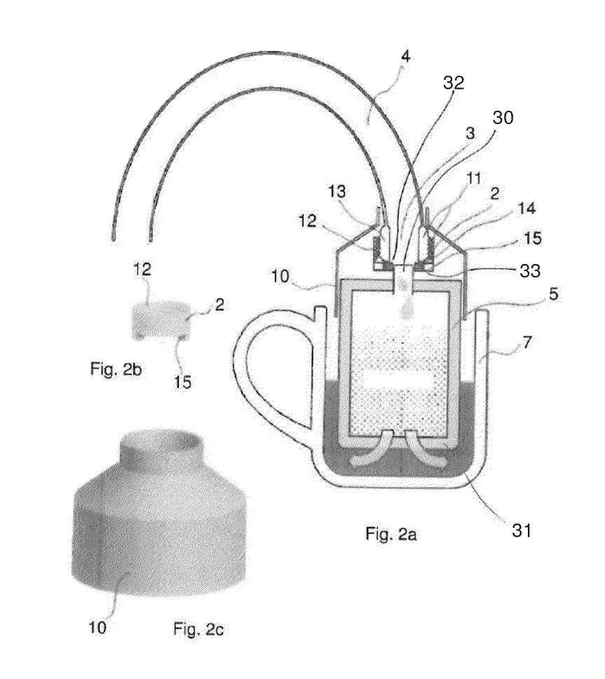

FIG. 2a shows a second embodiment of the system according to the invention and its relation to a faucet and a cup.

FIG. 2b shows a detailed perspective view of the device in FIG. 2a.

FIG. 2c shows a protector shown in FIG. 2a in a perspective view.

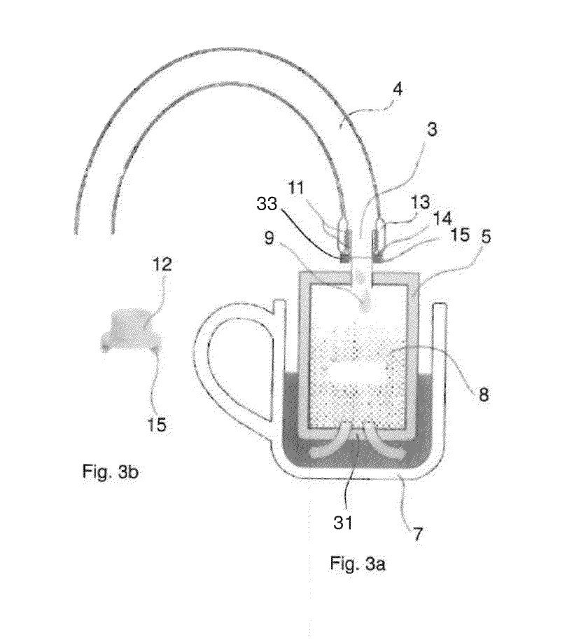

FIG. 3a shows a third embodiment of the system according to the invention and its relation to a faucet and a cup.

FIG. 3b shows a detailed perspective view of the device in FIG. 3a.

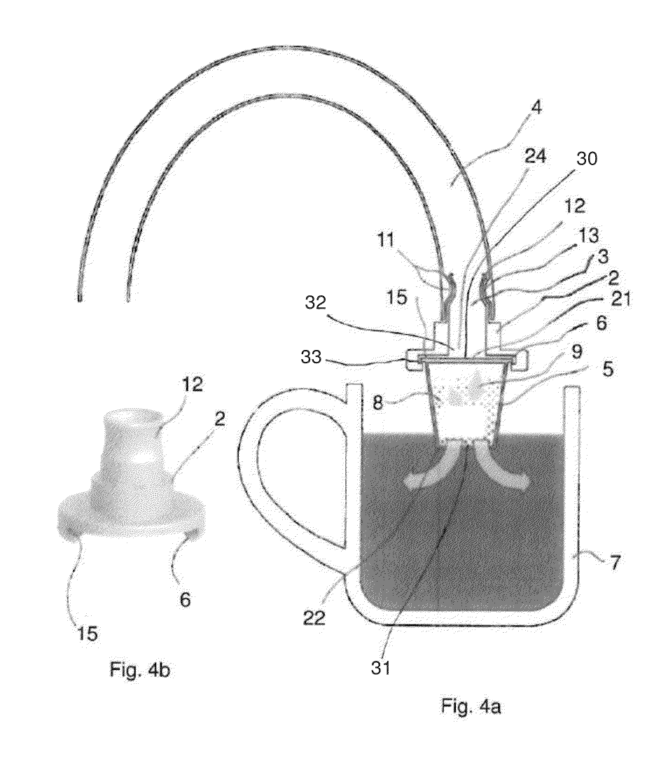

FIG. 4a shows a fourth embodiment of the system according to the invention and its relation to a faucet and a cup.

FIG. 4b shows a detailed perspective view of the device shown in FIG. 4a.

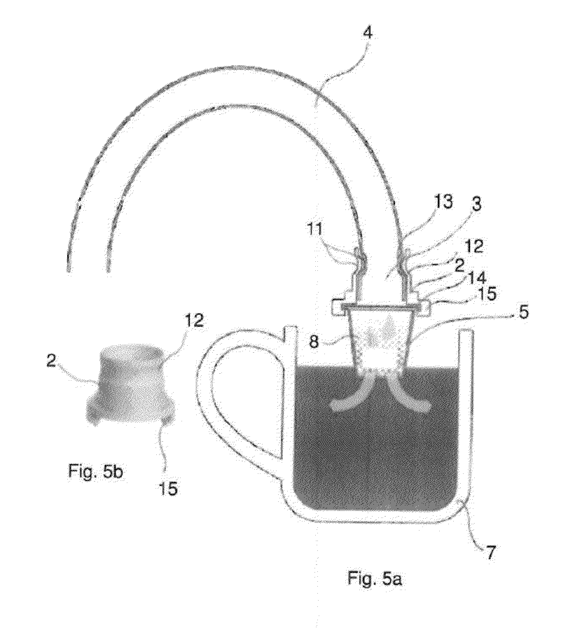

FIG. 5a shows a fifth embodiment of the system according to the invention and its relation to a faucet and a cup.

FIG. 5b shows a detailed perspective view of the device shown in FIG. 5a.

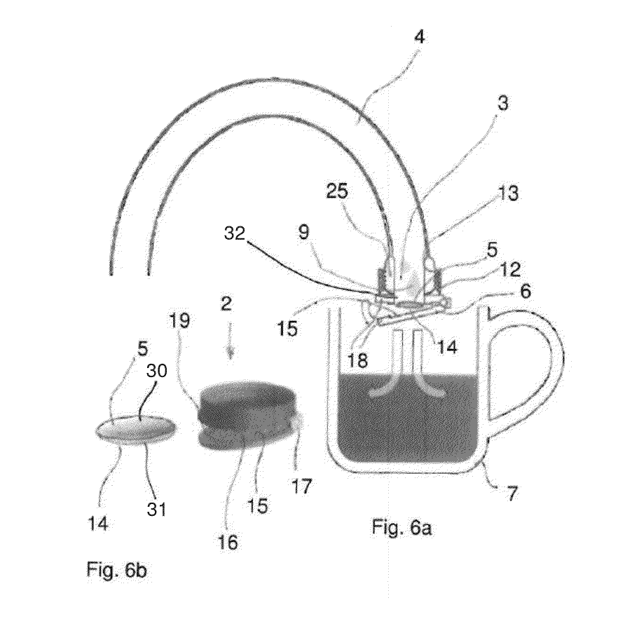

FIG. 6a shows a sixth embodiment of the system according to the invention and its relation to a faucet and a cup.

FIG. 6b shows a detailed perspective view of the device shown in FIG. 6a and a container formed as a pad suitable for the device.

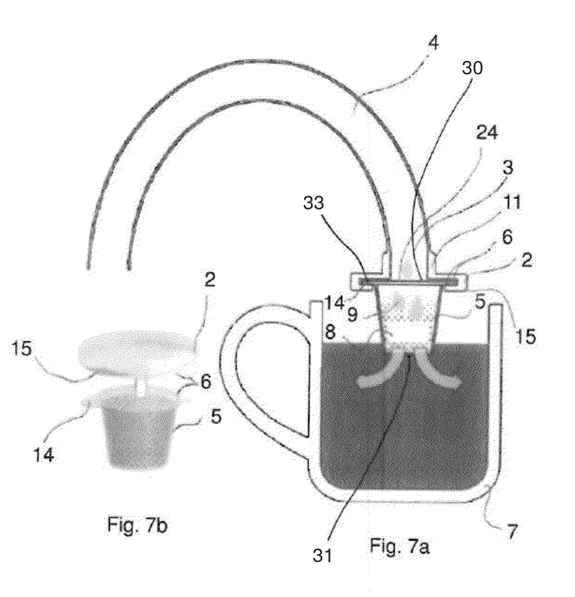

FIG. 7a shows a seventh embodiment of the system according to the invention and its relation to a faucet and a cup.

FIG. 7b shows a container with first position means and suitable for the device shown in FIG. 7a.

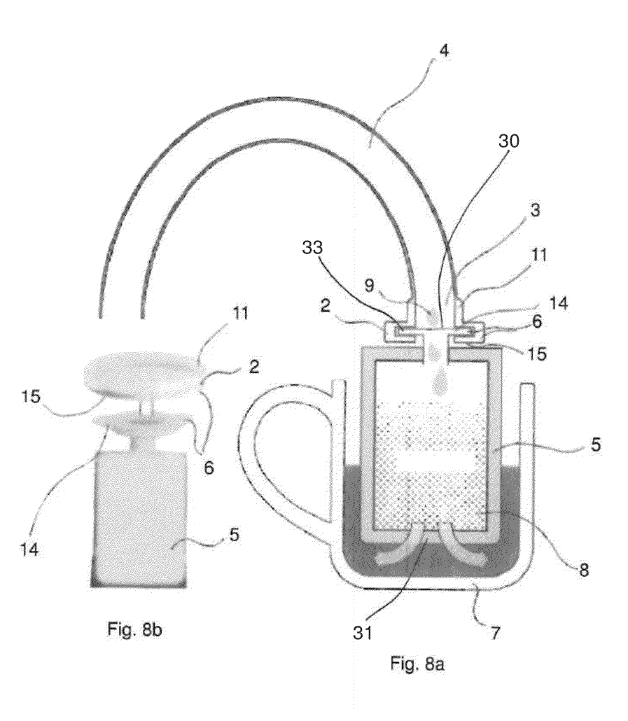

FIG. 8a shows an eighths embodiment of the system according to the invention and its relation to a faucet and a cup.

FIG. 8b shows a container with first position means and suitable for the device shown in FIG. 8a.

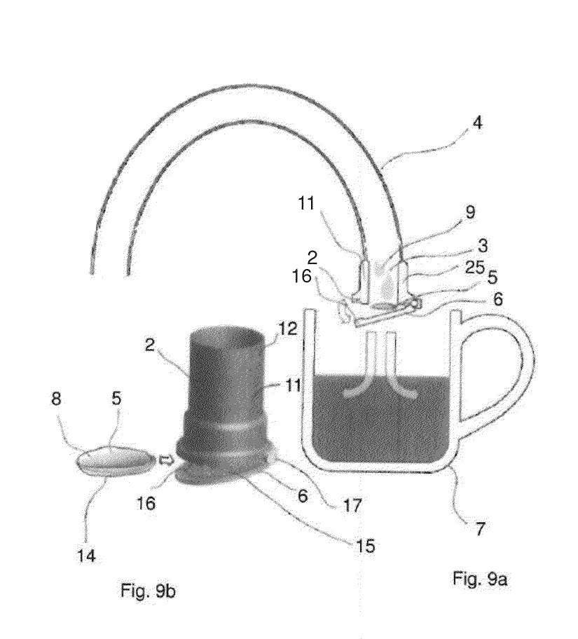

FIG. 9a shows a ninth embodiment of the system according to the invention and its relation to a faucet and a cup.

FIG. 9b shows a detailed perspective view of the device in FIG. 9a and a container formed as a pad suitable for the device.

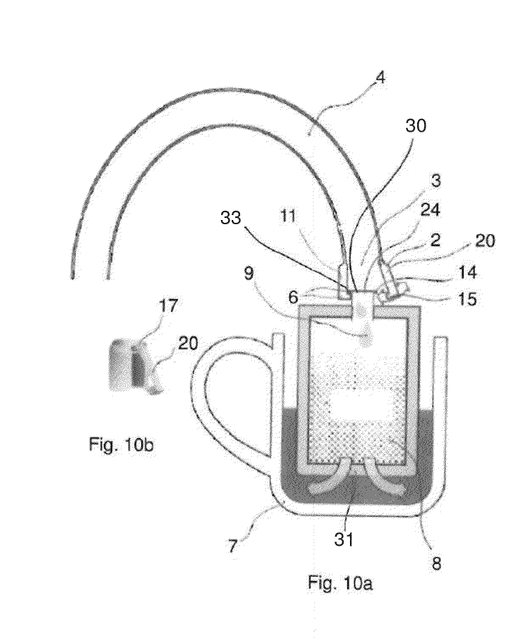

FIG. 10a shows a tenth embodiment of the system according to the invention and its relation to a faucet and a cup.

FIG. 10b shows a detailed perspective view of the device in FIG. 10a.

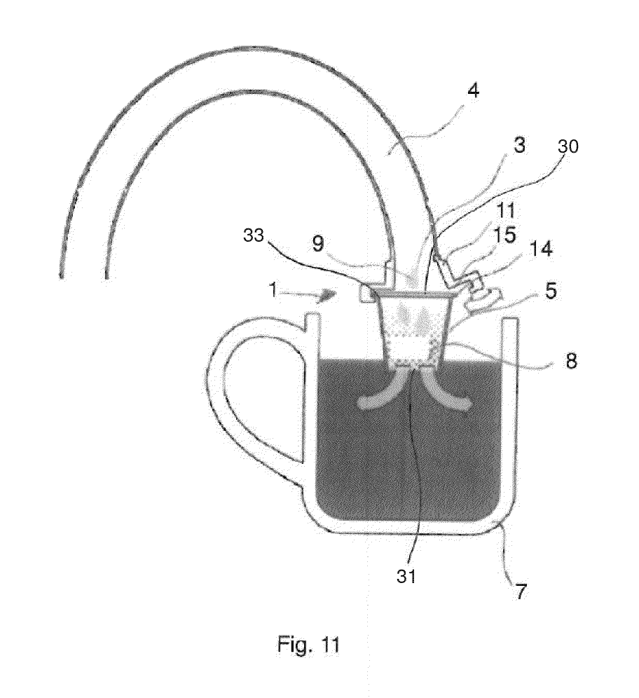

FIG. 11 a shows an eleventh embodiment of the system according to the invention and its relation to a faucet and a cup.

### DETAILED DESCRIPTION OF THE DRAWINGS

FIG. 1a shows a first embodiment of a system 1 and its relation to a faucet 4. The system comprises a container 5 made in a flexible sheet material, at least permeable in an inlet 24 of the container 5 for liquids 9 and a device 2 configured to cooperate with an outlet 3 of the faucet 4 and the container 5. The device 2 is made in a material nonpermeable for the fluid 9 such as polypropylene. The system comprises position means 6 configured to position and to retain the container 5 in a defined relation to the device 2. The positions means 6 comprise first position means 14 being a part of the container 5 and second positions means 15 being a part of the device 2. The first and second position means 14, 15 are configured to engage with each other. By the engagement, the container 5 is attached to the device 2. The first position means 14 are placed opposite the bottom of the container 5 and are formed as a plate with the inlet opening 24 placed in the middle of the plate and through which the liquid 9, such as hot water, passes. The inlet opening is placed in an inlet part being made of a hard plastic material; said inlet part is connected to the sheets by a flange welded to the sheets. The flange is a collar shaped 33 part and in the middle a fluid inlet 30 is placed. The fluid inlet 30 may comprise a single inlet or several minor inlets formed as perforations or being pores provided by the chosen material of the container. Opposite the fluid inlet 30, a fluid outlet 31 is placed comprising several minor outlets. They are made as perforations or comprise pores when the container is made in a non-woven material/paper/filter. The material of the container 5 encompasses a material 8, such as coffee powder or other tasty powders/liquids. This is dissolved or extracted by the liquid/hot water passing through the inlet 24. The rim of the plate 14/the collar 33 fits into a second position means 15 formed as a part-circular recess surrounding a part of the first position means 14 in a fluid-tight manner. The second position means 15 is a part of the separate device 2, said device 2 being a circular tube-formed adapter provided with internal threads opposite the second position means 15, said internal threads being first engaging means. The internal threads cooperate with external threads 13, i.e. second engaging means. These threads are placed at an outlet 3 of a fluid dispensing unit 4 being a faucet. The first 12 and second 13 engaging means comprise the engaging means 11 of the system 1 as such and connect the device 2 in a secure and liquid-tight manner to the faucets 4. The device is placed in a spout outlet 32 of the faucet 4.

FIG. 1b shows a part of the system 1 shown in FIG. 1a comprising the container 5 formed in a suitable laminate such as polyester, aluminium or polypropylene laminate. The container 5 is formed as a bag/pouch and is equivalent to the one shown in FIGS. 2a, 3a, 8a, 10a. The bag 5 is fastened to the outlet 3 of the faucet 4 by means of the device 2. One end of the device 2 comprises the first engaging means 12 (internal threads) screwed tightly to the external threads (the second engaging means) 13 belonging to the faucet 4. The first position means 14 (the plate of the bag 5/the collar 33) are pressed into the recess, the connection there-between being liquid-tight and as explained above. A cup 7 is placed under the bag 5, in this example it could be a coffee bag, boiling water 9 is led out of the faucets 4 and passes through the inlet 24 of the coffee bag 5 through the fluid inlet 30, as explained with reference to FIG. 1a, into the interior of the coffee bag and dissolves or extracts the material 8 placed inside said coffee bag. Afterwards, the liquid with the dissolved coffee powder or an extract thereof leaves the bag through the bottom part 22 of the bag 5 through the fluid outlet 31 of the container. The bag 5 comprises said bottom part 22 and an oppositely placed top part 21 comprising the inlet 24 for the fluid, and these parts are connected to each other with side parts 23. By said construction, a container formed as a bag is provided. The fluid may also leave the container 5 through the lower part of the side parts 23. The container may have many designs and may also be constructed as a pad or a cup-formed unit.

FIGS. 2a-2c show a second embodiment of the system 1. The system 1 is identical to the system 1 described with reference to FIGS. 1a-1b, but also includes a protector 10, see FIG. 2c. Said protector 10 encloses the device 2 and a part of the container 5. By said arrangement, boiling water escaping the system by accident is caught by the inside of the protector 10, which thereby protects a person from being hit and burned by the boiling water.

FIGS. 3a-3b disclose a third embodiment of the invention. The difference between this system 1 and the embodiment disclosed in FIGS. 1a-1b is the construction of the engaging means 11 comprising the first engaging means 12 and the second engaging means 13. The first engaging means 12 comprises externally placed threads cooperating with second engaging means 13 constructed as internal threads placed at the outlet 3 of the faucet 4.

FIGS. 4a-4b disclose a fourth embodiment of the system 1. The difference between this embodiment and the embodiment shown in FIGS. 3a-3b is the construction of the engaging means 11 and the construction of the container 5 and of the inlet 24. The first engaging means 12 of the device 2 are a connecting pipe that press-fits into a surrounding connecting pipe, this being the second connecting means 13 and a part of the outlet 3 of the faucet 4 (a pater/mater arrangement). The inlet 24 of the container 5 is configured as a perforation in the top part 21 of the container 5 providing the fluid inlet 30. The container 5 itself is constructed as a capsule with an outer contour formed as a pot enclosing the material 8. The material may be coffee powder, tea powder, soup and/or other flavoured fluids/powders. The fluid is led out of the container 5 through perforation in the bottom part 22 of the container 5.

The embodiment disclosed in FIGS. 5a-5b differs from the embodiment shown in FIGS. 4a-4b by the construction of the engaging means 11 of the device 2 and of the faucet 4. The first engaging means 12 of the device 2 are configured as an outer coupling pipe surrounding and press-fitting the second engaging means 13 of the faucet 4, also constructed as a coupling pipe and press-fitting into the first engaging means 12 (a pater/mater arrangement). Both containers shown in FIG. 4a and in FIG. 5a are provided with a circumferential stiff collar 33, which engages with the second positions means 15. Further, the container is provided with perforations in the top part 21 providing the fluid inlet 30 and in the bottom part 22 providing the fluid outlet 31. The diameter of the perforations is in the range of 50-300 my, preferably 100-250 my. FIGS. 6a-6b disclose a sixth embodiment of the invention comprising a container 5 formed as a pad. The walls of the pad is made in a flexible filter material, such as paper or a filter comprising polyethylene fibres in order to make it suitable for a welding process. The device 2 comprises first engaging means 12, and an outlet part 25 of the faucet 4 comprises second engaging means 13, said engaging means 13 constructed as the engaging means 11 shown in FIGS. 1a-1b. The position means 6 of the device 2, i.e. the second position means 15, are formed as a circular plate constructed as a strainer 16, the strainer 16 being connected to the device 2 with a hinge 17. The device is placed in the spout outlet 32. Thereby, the plate has an open position, where there is access to the interior of the outlet 3. The container 5 is formed as a pad and placed with one side resting at the strainer 16; said resting side of the pad being the first position means 14 of the container 5. The strainer 16 is closed and kept in place by a closing mechanism 18 and at said position the pad is resting against the surface of the strainer 16 as the strainer 16 is horizontally placed in its closed position. The boiling water is running through the pad 5, passing the fluid inlet 30 provided by the pores of the filter material and further leaving the pad through the fluid outlet 31 provided by the pores of the filter material dissolving/extracting the material 8 placed inside the pad 5. Fluid with extracted material flows through the strainer 16 into the cup 7.

FIGS. 7a-7b disclose a seventh embodiment of the invention comprising a container 5 similarly constructed as the container 5 shown in FIG. 5a. The position means 6 are also similar to the construction of the position means 6 shown in FIG. 5a. The device 2 may be an integral part of the outlet 3 of the faucet 4. With said construction, the engaging means 11 are not a separate unit disengagable from the outlet 3 of the faucet 4 but simply an integral part of the faucet. As a consequence, the second position means 15 are integrated with the faucet 4. With said construction, the second position means 15 and the engaging means 11 are all a structural integral part of the faucet 4. It is also possible that the device is a separate part and fastened to the faucets by a thread.

FIG. 8 is an eighth embodiment of the system according to the invention and differs from the embodiment shown in FIG. 7a only by the construction of the container 5 and the inlet 24. However, the container 5 and the inlet 24 are the same as the ones shown in the embodiment of FIG. 3a.

FIGS. 9a-9b are a ninth embodiment of the system according to the invention and the embodiment differs from the embodiment of FIGS. 6a-6b by the construction of the engaging means 11. The engaging means 11 comprise the first engaging means 12 constructed as a connecting pipe that press-fits into a second engaging means 13, connecting pipe, of the outlet 3 of the faucet 4 (a type of pater-mater arrangement). Alternatively, the outlet part 25 of the faucet is constructed as disclosed in FIG. 9b. The outlet part 25 of the faucet is ready to be used without the pad and thereby to be used as a simple faucet.

FIGS. 10a-10b are a tenth embodiment of the system according to the invention and the embodiment differs from the embodiment shown in FIG. 1a by the construction of the device 2. The device 2 is an integral part of the faucet 4 (it may however be an exchangeable part also) comprising a linked side plate 20. The side plate 20 is connected to the outlet 3 by a hinge 17. When the side plate 20 is open, it is possible to push the first position means 14 of the container 5, such as the one described with reference to FIG. 1a, into place in the outlet 3. Afterwards, the side plate 20 is closed, by which arrangement the container 5 is locked into a position for receiving boiling water through the inlet 24 by means of the second position means 15. In this example, the engaging means 11 is an integral part of the construction of the faucet 4.

The eleventh embodiment shown in FIG. 11 a differs from the one shown in FIG. 10 only by the construction of the container 5, this being a cup-formed container and as explained in FIGS. 4-7. However, the engaging means and the position means are constructed in a similar, principal manner as explained with reference to FIG. 10.

The device is made in a material that is rather strong and not deformable as it must be able to withstand the force when connecting the device to a faucet. When the device is an integral part of the faucet, it is made of the same material as the faucet or the outlet part of the faucet, such as hard strong plastic or stainless steel. The same applies to the engaging means. Also, the first position means must have certain strength so that it can carry the weight of the container. Advantageously, the first position means is made in a plastic material which may have certain flexibility in order to fit into the second position means.

The containers shown in FIGS. 1a, 2a, 3a, 4a, 5a, 7a, 8a, 10a and 11) are provided with a circumferential stiff collar 33, which engages with the second positions means 15. The second position means are configured as a part-circular recess into which the collar 33 press fits. Further, the containers are provided with several perforations making minor inlets or a single inlet as shown in FIG. 10a in the top part 21 and perforations in the bottom part 22. The inlets/outlets may also be provided with pores in the chosen material. The diameter of the perforations/pores is in the range of 50-300 my, preferably 100-250 my.

### list of references

System 1

Device 2

Outlet 3 (faucet)

Tap/faucet 4

Container 5

Position means 6 (connection container 5/device)

Cup 7

Material 8

Fluid 9

Protector 10

Engaging means 11 (connection faucet/device)

First engaging means 12 (device)

Second engaging means 13 (faucet)

First positions means 14 (container 5)

Second positions means 15 (device)

Strainer 16

Hinge 17

Closure mechanism 18

Plate 19

Side plate 20

Top part 21

Bottom part 22

Side parts 23

Inlet 24

Outlet part 25

Fluid inlet 30 (container)

Fluid outlet 31 (container)

Spout outlet 32

Collar 33

1. System (1) for handling a material (8) of solid particles such as granular, flakes or powder into a fluid stream, said fluid stream being a water stream, the system comprising a container (5) enclosing the material (8), said container cooperating with an outlet (3) of a tap or faucet (4) comprising a spout having a spout outlet and at least a part of the container (5) being permeable for the fluid (9) dispensed from the (4) tap/faucet (4), said system (1) further comprising a device (2) configured to cooperate with the outlet and the container (5), said device (2) being made in a material non-permeable for the fluid (9), and said system comprising position means (6) configured to position and to sustain the container (5) in a defined relation to said device (2), said container comprising a top part (21), a bottom part (22), side parts (23), a fluid inlet and a fluid outlet, characterised in that the device is adapted to be placed in the spout outlet (32) and the fluid inlet (30) is placed in the top part of the container and the outlet (31) is placed in the oppositely placed bottom part (22) and/or lower part of the side parts (23), whereby the fluid passes through the solid particles (8) from the top to the lower part of the container (5) extracting the flavour and nutrients of the solid particles.

2. System (1) according to claim 1, characterised in that the fluid inlet (30) comprises pores or perforations, said pores or perforations having a diameter of 50 my-300 my.

3. System (1) according to claim 1, characterised in that that the fluid inlet (30) comprises pores or perforations, said pores or perforations having a diameter of 100 my-250 my.

4. System (1) according to claim 1, characterised in that the fluid outlet (31) comprises pores or perforations, said pores or perforations having a diameter of 50 my-300 my.

5. System (1) according to claim 1, characterised in that the fluid outlet (31) comprises pores or perforations, said pores or perforations having a diameter of 100 my-250 my.

6. System (1) according to claim 1, characterised in that the fluid inlet (30) comprises one single inlet allowing the water to pass through with little resistance.

7. System (1) according to claim 1, characterised in that the pressure of the fluid (9) is 2-8 bar and said pressure is constant during the extraction of the flavour/nutrients.

8. System (1) according to claim 1, characterised in that the tap/faucet (4) comprises a boiling water faucet/tap (4), said water leaving the faucet/tap having a certain unchangeable pressure and a temperature in the range of 70-100° C.

9. System (1) according to claim 1, characterised in that the container (5) comprises a capsula, said bottom part and top part of the capsula being made in a polymer material and comprising perforations through which the fluid passes.

10. System (1) according to claim 1, characterised in that the walls of the container (5) have a thickness of 400-600 my.

11. System (1) according to claim 1, characterised in that the inlet (30) of the container comprises several minor inlets and the outlet (31) of the container comprises several minor outlets.

12. System (1) according to claim 1, characterised in that the container is made in a non-woven material and the inlet and the outlet comprise the pores of the material.

13. System (1) according to claim 1, characterised in that the outlet is placed in the bottom part of the container (5), whereby the fluid passes through the bottom when leaving the container.

14. System (1) according to claim 1, characterised in that the container (5) comprises a circumferential collar (33), said collar being adapted to engage the device (2).

15. System (1) according to claim 14, characterised in that the second position means (15) comprises a part circular recess, the collar (33) being adapted to press fit into said recess.

16. System (1) according to claim 1, characterised in that said system (1) further comprises engaging means (11) for engaging the device (2) and the fluid dispensing unit (4).

17. System (1) according to claim 1, characterised in that the position means (6) comprise first position means (14) being a part of the container (5) and second positions means (15) being a part of the device (2), said first and second position means (14, 15) being configured to engage with each other, whereby the container (5) is attached to the device (2).

18. System (1) according to claim 16, characterised in that the engaging means (11) comprise first engaging means (12) being an integrated part of the device (2) and second engaging means (13) being a part of the outlet (3), said first and second engaging means (12,13) being configured to interconnect.

19. System (1) according to claim 18, characterised in that the first engaging means (12) are formed as a pater part fitting into the second engaging means (13) formed as a mater part surrounding the pater part, or the first engaging means (12) are formed as a mater part surrounding the second engaging means (13) formed as a pater part, said mater and pater part fitting each other.

20. System (1) according to claim 18, characterised in that the first and the second engaging (13) means are formed as threads engaging with each other.

21. System (1) according to claim 1, characterised in that the device (2) is an integral part of the outlet (3) of the fluid dispensing unit (4), whereby the engaging means (11) comprise the device (2) and an outlet part (25) of the fluid dispensing unit (4), said two parts being formed as one unit.

22. System (1) according to claim 1, characterised in that the device (2) is a separate unit such as an adapter.

23. System according to claim 17, characterised in that the first (14) and the second (15) position means are formed as an integral unit and are inseparable.

24. System (1) according to claim 17, characterised in that the first position means (14) are formed as a connecting pipe fitting into the second position means 15 being formed as a recess enclosing at least a part of the connecting pipe, whereby the first (14) and the second (15) position means are configured to be separable.

25. System (1) according to claim 23, characterised in that the second position means (15) comprise a hinged and liquid-permeable plate (19) covering the outlet (3) of the fluid dispensing unit (4), said plate (19) being able to have at least two positions, a first position where the plate is covering the outlet and comprises means for firmly securing the plate (19) to the outlet (3), and a second position—an open position—where there is access to the outlet (3).

26. System (1) according to claim 25, characterised in that the second position means (15) comprise a hinged side plate (20), said side plate (20) being hinged in such a way that in a closed position, the longitudinal axis of the plate (20) is parallel to the longitudinal axis of the outlet (3) and is angled with the longitudinal axis in an open position, said angle being measured where a hinge (17) is placed.

27. Container suitable for a system according to claim 1, characterised in that the container (5) comprises an article enclosing the material (8), and the container (5) further comprises first position means (14) configured to engage a device (2) or an outlet being part of a fluid dispensing unit, said at least a part of the container (5) being permeable for the liquid dispensed from the fluid dispensing unit, said fluid dispensing unit being a faucet/tap.
